(19) United States
(12) Patent Application Publication
(10) Pub. No.: US 2025/0096373 A1
(43) Pub. Date: Mar. 20, 2025

(54) CELL POUCH FOR SECONDARY BATTERY AND ITS MANUFACTURING METHOD

(71) Applicant: Dongwon Systems Corporation, Seongnam-si (KR)

(72) Inventors: Eui Hwan SONG, Seoul (KR); Sung Gi YOON, Cheonan-si (KR); Jong An KIM, Ansan-si (KR); Gyu Woon JUNG, Seoul (KR); Hyun Ah LEE, Sejong-si (KR); Seung Hyeon YEON, Bucheon-si (KR)

(73) Assignee: Dongwon Systems Corporation, Seongnam-si (KR)

(21) Appl. No.: 18/535,670

(22) Filed: Dec. 11, 2023

(30) Foreign Application Priority Data
Sep. 14, 2023 (KR) 10-2023-0122476

(51) Int. Cl. H01M 50/129; H01M 50/105; H01M 50/121; H01M 50/131

(52) U.S. Cl. CPC H01M 50/129; H01M 50/105; H01M 50/121; H01M 50/131

(57) ABSTRACT

In a secondary battery, a cell pouch for a secondary battery according to the present invention comprises an inner resin layer, a barrier layer, and an outer resin layer, wherein the inner resin layer, the barrier layer, and the outer resin layer are sequentially laminated, wherein a content ratio of PER (Propylene Ethylene Rubber) in the inner resin layer is 10% or less. According to the present invention, the electrolyte peel strength of the secondary battery cell is improved to ensure excellence and reliability, as well as it is possible to use a cell pouch for a secondary battery with excellent conditions such as an electrolyte peeling strength of 1,000 (gf/15 mm) or more, due to the property, in which the electrolyte peel strength of the secondary battery cell is inversely proportional to the content ratio of PER in the inner resin layer and is proportional to the length of PER.

### CROSS-REFERENCE TO RELATED APPLICATIONS

This application claims the benefit of Korean Application No. 10-2023-0122476, filed Sep. 14, 2023, in the Korean Intellectual Property Office. All disclosures of the document named above are incorporated herein by reference.

### TECHNICAL FIELD

The present invention relates to a cell pouch for secondary batteries and a method of manufacturing the same. In particular, it relates to a cell pouch for secondary batteries having excellent chemical resistance properties based on the PER (Propylene Ethylene Rubber) content ratio of the internal resin layer and the PER length and the manufacturing method for the same.

### BACKGROUND ART

Those described in this background art section are written to improve understanding of the background of the invention, and may include matters that are not prior art already known to those skilled in the art in the field to which this technology belongs.

Pouch-type secondary batteries have the advantage of having great freedom of design in terms of their shape and of being able to achieve the same capacity with a smaller volume and mass. This aluminum pouch for secondary batteries protects the secondary battery cells, into which electrolyte is introduced, by the electrode assembly and subsequent processes, and has an aluminum thin film interposed thereto to complement the electrochemical properties of the secondary battery cells and improve heat dissipation.

A pouch for secondary batteries is used as an exterior material that has the advantage of being able to freely modify the shape of the secondary battery and includes a multi-layer structure (e.g., inner layer, barrier layer, outer layer). Inside the cell, there are the active materials of the positive and negative electrodes and electrolytes, so chemical resistance properties are necessary.

### RELATED PATENT LITERATURE

Korean Patent Registration No. 10-2064460

### DISCLOSURE

### Technical Problem

The purpose of the present invention is to provide a cell pouch for secondary batteries, which improves the electrolyte peel strength of secondary battery cells to ensure excellence and reliability and a method for manufacturing the same.

The present invention is to provide a cell pouch for secondary batteries having an excellent condition of the electrolyte peel strength being more than 1,000 (gf/15 mm), using a property, in which the electrolyte peel strength of the secondary battery cell is inversely proportional to the content ratio of PER in the internal resin layer and proportional to the length of PER.

### Technical Solution

In order to achieve the above object, according to an embodiment of the present invention, a cell pouch for a secondary battery comprises an inner resin layer, a barrier layer, and an outer resin layer, wherein the inner resin layer, the barrier layer, and the outer resin layer are sequentially laminated, wherein a content ratio of PER (Propylene Ethylene Rubber) in the inner resin layer is 10% or less.

Further, the length of the PER of the inner resin layer may be 0.3 μm or more, or the length of the PER compared to the content ratio of the PER may be 3.0 (μm/%) or more.

Further, an electrolyte peeling strength of the inner resin layer may be 1,000 (gf/15 mm) or more.

Further, a first outer resin layer and a second outer resin layer may be sequentially laminated in the outer resin layer.

Further, the cell pouch may further comprise a first surface treatment layer formed between the inner resin layer and the barrier layer, and a second surface treatment layer formed between the barrier layer and the first outer resin layer.

Further, the cell pouch may further comprise a first adhesive layer formed between the second surface treatment layer and the first outer resin layer, and a second adhesive layer formed between the first outer resin layer and the second outer resin layer.

In order to achieve another object, according to an embodiment of the present invention, a method for manufacturing a cell pouch for a secondary battery comprises placing an inner resin layer, placing a barrier layer above the inner resin layer, and placing the outer resin layer above the barrier layer, wherein a content ratio of PER (Propylene Ethylene Rubber) of the inner resin layer is 10% or less.

Further, the length of PER of the inner resin layer may be 0.3 μm or more, or the length of the PER compared to a content ratio of the PER may be 3.0 (μm/%) or more.

Further, a first outer resin layer and a second outer resin layer may be sequentially laminated in the outer resin layer.

Further, a first surface treatment layer may be formed between the inner resin layer and the barrier layer, and a second surface treatment layer may be formed between the barrier layer and the first outer resin layer.

Further, a first adhesive layer may be formed between the second surface treatment layer and the first outer resin layer, and a second adhesive layer may be formed between the first outer resin layer and the second outer resin layer.

### Advantageous Effects

According to the present invention, the peeling strength of the electrolyte of the secondary battery cell is improved to ensure excellence and reliability.

According to the present invention, by using properties, in which the electrolyte peel strength of the secondary battery cell is inversely proportional to the content ratio of PER in the internal resin layer and is proportional to the length of PER, cell pouches for secondary batteries with excellent conditions of the electrolyte peel strength being 1,000 (gf/15 mm) or more can be used.

### BRIEF DESCRIPTION OF DRAWINGS

These and/or other aspects will become apparent and more readily appreciated from the following description of the embodiments, taken in conjunction with the accompanying drawings in which:

FIG. 1 is a structural diagram of a cell pouch for a secondary battery according to an embodiment of the present invention;

FIG. 2 is a structural diagram of an internal resin layer made of multiple layers according to an embodiment of the present invention;

FIG. 3 is a structural diagram of an outer resin layer, in which a second outer resin layer is laminated above a first outer resin layer according to an embodiment of the present invention.

FIG. 4 is a structural diagram of a cell pouch, in which a first surface treatment layer and a second surface treatment layer are laminated according to an embodiment of the present invention.

FIG. 5 is a structural diagram of a cell pouch, in which a first adhesive layer and a second adhesive layer are laminated according to an embodiment of the present invention.

### DETAILED DESCRIPTION OF EMBODIMENTS

The advantages and features of the present invention and how to achieve them will become clear with reference to the embodiments described below in conjunction with the accompanying drawings. However, the present invention is not limited to the embodiments disclosed below and may be implemented in various different forms. Only the examples are provided to make the disclosure of the present invention complete and to fully inform those skilled in the art of the present invention of the scope of the invention, and the present invention is defined by the scope of the claims.

### 1) Definition of Terms

The terminology used herein is only used to describe exemplary implementations and is not intended to limit the present invention. Singular expressions include plural expressions unless the context clearly dictates otherwise.

“Combination thereof” means a mixture of constituents, a laminate, a composite, a copolymer, an alloy, a blend, a reaction product, etc.

Terms such as “include,” “equipped with,” or “have” are intended to designate the presence of implemented features, numbers, steps, components, or combinations thereof, and should be understood that this does not exclude in advance the presence or addition of one or more other features, numbers, steps, components, or combinations thereof.

In the drawings, the thickness is enlarged to clearly express various layers and regions, and similar parts are given the same reference numerals throughout the specification. When a part of a layer, membrane, region, plate, etc. is said to be “on” or “above” another part, this includes not only cases where it is “directly above” another part, but also cases where there is another part in between. Conversely, when a part is said to be “directly above” another part, it means that there is no other part in between.

“Layer” includes not only the shape formed on the entire surface when observed in plan view, but also the shape formed on some surfaces.

“Moiety” refers to a certain part or unit derived from a specific compound when the specific compound participates in a chemical reaction and is included in the product of the chemical reaction. Specifically, in the cross-linked polymer, the ‘residue’ derived from a carboxylic acid-based monomer or its salt, the ‘residue’ derived from an acrylamide-based monomer, and the ‘residue’ derived from a (meth)acrylate-based monomer refers to a portion derived from a carboxylic acid monomer or a salt thereof, a portion derived from an acrylamide monomer, and a portion derived from a (meth)acrylate monomer having a glycidyl group, respectively.

### 2) Cell Pouch for Secondary Battery (100)

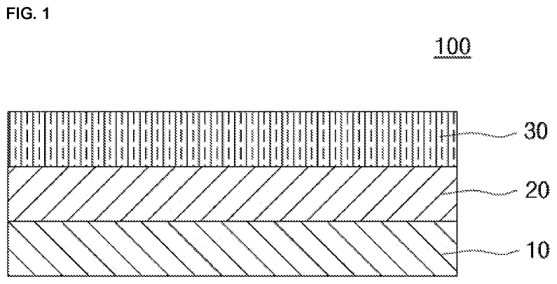

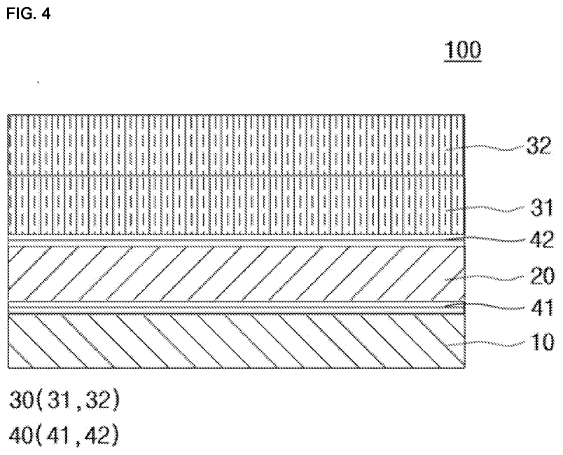

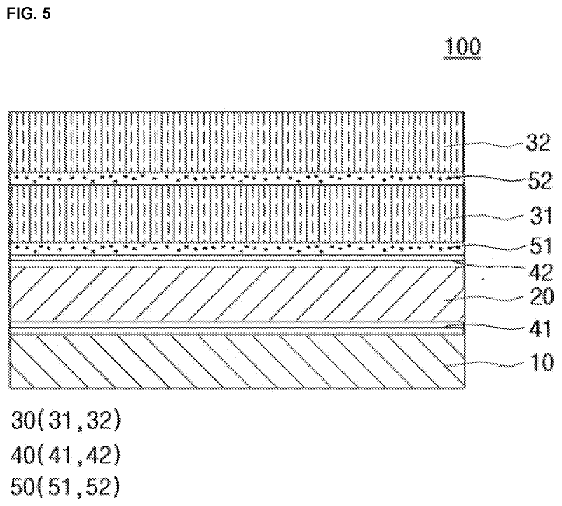

As shown in FIG. 1, the cell pouch 100 for a secondary battery is sequentially laminated with an inner resin layer 10, a barrier layer 20, and an outer resin layer 30. Additionally, a surface treatment layer 40 and an adhesive layer 50 may be further formed as shown in FIGS. 4 and 5, respectively.

### (A) Internal Resin Layer (10)

The internal resin layer (or PP (polypropylene)) 10 is disposed on the innermost side of the secondary battery and may function to provide chemical resistance properties such as electrolyte peel strength to chemicals inside the secondary battery. And, the polymer resin of the internal resin layer 10 may include polypropylene-based resin.

Rubber among the polypropylene raw materials of the internal resin layer 10 is EPR (Ethylene Propylene Rubber) or PER (Propylene Ethylene Rubber), which are copolymers of propylene and ethylene, and a polymer produced during the manufacturing process of polypropylene impact copolymer or heterophasic copolymer and has the characteristics of rubber.

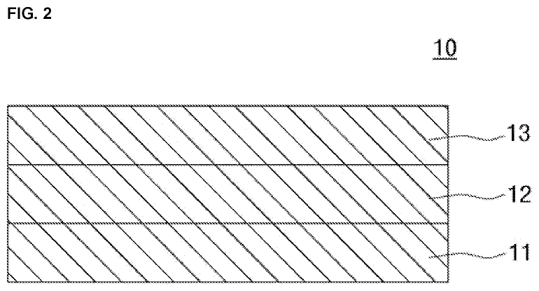

The internal resin layer 10 can be formed as a single-layer structure, but it is advantageous to be formed as a multi-layer structure in terms of giving it more diverse functions. For example, the inner resin layer 10 may include a first layer 11, a second layer 12, and a third layer 13 sequentially laminated as shown in FIG. 2. The first layer 11, the second layer 12, and the third layer 13 may be a first skin layer, a core layer, and a second skin layer, respectively.

The internal resin layer 10 can be bonded (heat-fused) by heat after the cell is embedded (packaged) to provide sealing properties. The inner resin layer 10 may have a total thickness of about 20 to 120 um for good thermal bonding strength, that is, improved heat resistance as well as sealing properties.

If the total thickness of the internal resin layer 10 is too thin, less than approximately 20 um, the electrolyte may leak or the packaged cell may not be sufficiently insulated due to insufficient sealing properties, and it may be difficult to secure a sufficient degree of heat resistance.

If the thickness of the internal resin layer 10 is too thick, exceeding about 120 um, it is relatively difficult for other layers provided above the internal resin layer 10 to have a sufficient thickness, thereby reducing the strength, barrier properties or formability of the cell pouch 100. The internal resin layer 10 may have a thickness of approximately 20 um, 30 um, 40 um, 60 um, 80 um, 100 um, and 120 um, but is not limited thereto.

### (B) Barrier Layer (20)

The barrier layer 20 prevents oxygen or moisture from penetrating from the outside. A suitable material for the metal thin film used as the barrier layer 20 is aluminum or an aluminum alloy.

Aluminum alloys include alloys made by adding various metals and non-metals to pure aluminum or stainless steel alloys. The aluminum layer is preferably made of soft aluminum foil, and more preferably, aluminum foil containing iron can be used to provide formability to the aluminum foil. Since aluminum foils with high purity have excellent processability, aluminum alloy foils in the 1000 or 8000 range are preferable.

Also, the aluminum substrate may be an alloy containing an element selected from the group consisting of silicon, boron, germanium, arsenic, antimony, copper, magnesium, manganese, zinc, lithium, iron, chromium, vanadium, titanium, bismuth, potassium, tin, lead, zirconium, nickel and combinations thereof.

The aluminum foil containing iron may preferably contain 0.1 to 9.0 mass %, and more preferably 0.5 to 2.0 mass %. If the iron content of the aluminum foil is less than 0.1 mass %, the ductility of the aluminum layer deteriorates, and if it exceeds 9.0 mass %, formability deteriorates.

It is possible to etch or degrease the surface of the aluminum foil used in the aluminum layer to improve adhesion to the internal resin layer, but this can be omitted to reduce process speed.

The aluminum layer is intended to prevent gas and water vapor from penetrating the interior of the battery from the outside, and the aluminum thin film needs to be free of pinholes and processability (pouching, embossing).

The thickness is preferably 10 to 100 μm, and more preferably 30 to 60 μm, considering processability, oxygen and moisture barrier properties, etc. If this range is not satisfied, if it is less than 10 μm, it is easily torn and electrolyte resistance and insulation properties are poor, and if it exceeds 60 μm, formability is poor.

### (C) Outer Resin Layer (30)

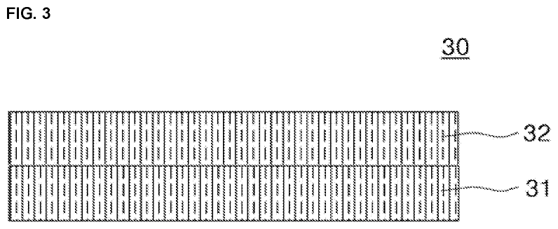

The outer resin layer 30 is disposed on the outermost side of the secondary battery. As shown in FIG. 3, the outer resin layer 30 may be formed by sequentially laminating a first outer resin layer 31 and a second outer resin layer 32. At this time, the first outer resin layer 31 may be polyethylene terephthalate (PET), and the second outer resin layer 32 may be a nylon film.

Because the outer resin layer 30 corresponds to the area in direct contact with hardware, it is preferably a resin with insulating properties. Therefore, the resin used as the outer resin layer 30 may be a polyester resin such as polyethylene terephthalate, polybutylene terephthalate, polyethylene naphthalate, polybutylene naphthalate, copolymerized polyester, or polycarbonate, or it is preferable to use a nylon film.

Polyester resins may specifically include polyethylene terephthalate (PET), polybutylene terephthalate (PBT), polyethylene naphthalate (PEN), polybutylene naphthalate (PBN), copolymerized polyester, polycarbonate (PC), etc.

Polyester specifically may include polyethylene terephthalate, polybutylene terephthalate, polyethylene naphthalate, polybutylene naphthalate, polyethylene isophthalate, polycarbonate, copolymerized polyester with ethylene terephthalate as the main repeating unit, and copolymerized polyester with butylene terephthalate as the main repeating unit.

Additionally, copolymerized polyesters with ethylene terephthalate as the main repeating unit may specifically include copolymerized polyester polymerized with ethylene isophthalate with ethylene terephthalate as the main repeating unit, and polyethylene (terephthalate/isophthalate), polyethylene (terephthalate/adipate), polyethylene (terephthalate/sodium sulfoisophthalate), polyethylene (terephthalate/sodium isophthalate), polyethylene (terephthalate/phenyl-dicarboxylate), polyethylene (terephthalate/decanedicarboxylate), etc.

Additionally, copolymerized polyesters with butylene terephthalate as the main repeating unit may specifically include copolymer polyesters polymerized with butylene isophthalate using butylene terephthalate as the main repeating unit, polybutylene (terephthalate/adipate), polybutylene (terephthalate/sebacate), polybutylene (terephthalate/decanedicarboxylate), polybutylene naphthalate, etc. These polyesters may be used individually or in a combination of two or more types.

Polyamide resins may include, specifically, aliphatic polyamides such as nylon 6, nylon 66, nylon 610, nylon 12, nylon 46, and copolymers of nylon 6 and nylon 66; Hexamethylenediamine-isophthalic acid-terephthalic acid copolymer polyamides such as nylon 6I, nylon 6T, nylon 6IT, and nylon 6I6T (I represents isophthalic acid and T represents terephthalic acid) containing structural units derived from terephthalic acid and/or isophthalic acid; polyamides containing aromatics such as polymethoxylene adipamide (MXD6); alicyclic polyamides such as polyaminomethylcyclohexyl adipamide (PACM6); polyamides that are copolymerized with lactam components or isocyanate components such as 4,4′-diphenylmethane-diisocyanate, polyesteramide copolymer or polyetheresteramide copolymer; and polyesteramide copolymer or polyetheresteramide copolymer, which is a copolymer of copolymerized polyamide and polyester or polyalkylene ether glycol. These polyamides can be used individually or in a combination of two or more types.

As a packaging film for secondary batteries in such an outer resin layer 30, it is particularly desirable to use a nylon film. In the case of nylon film, it is mainly used as a packaging film because it not only has excellent bursting strength, pinhole resistance, and gas barrier properties, but also has excellent heat resistance, cold resistance, and mechanical strength.

Specific examples of nylon films include polyamide resins, that is, nylon 6, nylon 66, copolymers of nylon 6 and nylon 66, nylon 610, polymethoxylinene amidipamide (MXD6), etc.

When laminating the outer resin layer 30, the thickness of the laminated outer resin layer 30 is preferably 10 to 30 μm or more, and particularly preferably 12 to 25 μm. If this range is not satisfied, if it is less than 10 μm, the physical properties are poor and easily torn, and if it exceeds 30 μm, formability is poor.

### (D) Surface Treatment Layer (40)

Referring to FIG. 4, the surface treatment layer 40 may be formed on the upper and lower surfaces of the barrier layer 20, and may provide corrosion resistance and adhesiveness to the barrier layer 20.

For clarity of notation, the surface treatment layer formed between the internal resin layer 10 and the barrier layer 20 may be referred to as the first surface treatment layer 41, and the surface treatment layer formed between the barrier layer 20 and the first outer resin layer may be referred to as the second surface treatment layer 42.

In addition, the surface treatment layer 40 may include at least one of an acrylic polymer or a salt thereof, a chromium-based compound, and a phosphoric acid-based compound.

In addition, the surface treatment layer 40 has an acrylic polymer or a salt thereof, which can function as a binder that binds the chromium-based compound and the phosphoric acid-based compound, and also improve the durability of the surface treatment layer 40 and the secondary batteries including the same.

Acrylic polymers or salts thereof may be at least one selected from the group including polyacrylic acid, ammonium salt of polyacrylic acid, sodium salt of polyacrylic acid, amine salt of polyacrylic acid, a copolymer of acrylic acid and dicarboxylic acid (or dicarboxylic acid anhydride), an ammonium salt of a copolymer, a sodium salt of a copolymer, and an amine salt of a copolymer.

The chromium-based compound may be at least one selected from the group including acetylacetate chromate, chromium chloride, chromium potassium sulfate, chromium nitrate, chromium fluoride, chromium sulfate, chromium acetate, chromium oxalate, chromium bioxide, etc.

The phosphoric acid-based compound may be at least one selected from the group including sodium phosphate, potassium phosphate, ammonium phosphate, polyphosphoric acid, etc.

### (E) Adhesive Layer (50)

An adhesive layer 50 may be laminated for adhesion of the cell pouch 100 for a secondary battery. The adhesive layer 50 is formed between the outer resin layer 30 and the surface treatment layer 40 or between the outer resin layer 30 and the barrier layer 20 for adhesion. When the outer resin layer 30 has a multi-layer structure of two or more layers, two or more adhesive layers may be formed. For example, when the outer resin layer 30 has two layers, a first adhesive layer 51 may be formed between the first outer resin layer 31 and the second outer resin layer 32, and a second adhesive layer 52 may be formed between the second outer resin layer 32 and the surface treatment layer 40.

The adhesive layer 50 is formed of an adhesive resin capable of bonding. The adhesive resin may be a two-component curing type adhesive resin or a one-component curing type adhesive resin. Additionally, the bonding mechanism of the adhesive resin is not particularly limited, and may be any of the chemical reaction type, solvent volatilization type, heat melt type, and heat pressure type.

Resin components of adhesive resins may include, specifically, polyester resins such as polyethylene terephthalate, polybutylene terephthalate, polyethylene naphthalate, polybutylene naphthalate, polyethylene isophthalate, polycarbonate, and copolyester; polyether adhesive; polyurethane-based adhesive; epoxy resin; phenolic resin-based resin; polyamide resins such as nylon 6, nylon 66, nylon 12, and copolyamide; polyolefin-based resins such as polyolefin, acid-modified polyolefin, and metal-modified polyolefin; polyvinyl acetate-based resin; cellulose-based adhesive; (meth)acrylic resin; polyimide resin; amino resins such as urea resin and melamine resin; rubbers such as chloroprene rubber, nitrile rubber, and styrene-butadiene rubber; silicone-based resin; and ethylene fluoride propylene copolymer. These adhesive resin components may be used individually, or two or more types may be used in combination.

There is no particular limitation on the form of combination of two or more types of adhesive resin components, but for example, as the adhesive resin component, it may be a mixed resin of polyamide and acid-modified polyolefin, a mixed resin of polyamide and metal-modified polyolefin, a mixed resin of polyamide and polyester, or polyester and acid-modified polyolefin, a mixed resin of polyester and metal-modified polyolefin, etc.

Among these, it is preferable to use a polyurethane-based two-liquid curable adhesive resin; polyamide, polyester, and blended resins of these and modified polyolefin since they are excellent in malleability, durability under high humidity conditions, anti-stooling action, deterioration suppression effect during heat sealing, etc., and effectively prevent the occurrence of delamination by suppressing the decrease in lamination strength between the base material layer and the metal layer.

The adhesive layer 50 can be formed using a material known as an adhesive used for laminating resin films or resin films and aluminum. Examples of the adhesive include polyurethane-based adhesives containing a base material containing polyols such as polyester polyol, polyether polyol, acrylic polyol, and carbonate polyol, and a curing agent containing a bifunctional or higher isocyanate compound. A polyurethane-based resin is formed by applying a curing agent to such a base material.

### 3) Change in Electrolyte Peel Strength According to PER (Propylene Ethylene Rubber) Content Ratio (%), PER Length (μm), and PER Length/PER Content Ratio (μm/%)

As shown in Table 1, the change will be examined in electrolyte peel strength according to PER (Propylene Ethylene Rubber) content ratio (%), PER length (μm), and PER length/PER content ratio (μm/%).

Here, the composition ratio of the electrolyte is 1M LiPF6 at EC:DMC:DEC=1:1:1 (v/v). After adding water (1000 ppm) to the electrolyte, the pouch was immersed, and after 24 hours at 85° C., the peeling strength of the electrolyte between aluminum (Al) and polypropylene was measured. EC is a cyclic carbonate with high dielectric constant and viscosity that dissolves the salt in lithium-ion batteries and is used as a basic solvent. DMC and DEC are chain carbonates with low dielectric constant and low viscosity and are used as co-solvents.

TABLE 1

| | Case | Case | Case | Case | Case | Case | Case | Comp. | Comp. | Comp. | Comp. |
|---|---|---|---|---|---|---|---|---|---|---|---|
| Category | 1 | 2 | 3 | 4 | 5 | 6 | 7 | 1 | 2 | 3 | 4 |
| PER | 2 | 3 | 6 | 9 | 10 | 10 | 10 | 11 | 12 | 11 | 14 |
| content | | | | | | | | | | | |
| ratio (%) | | | | | | | | | | | |
| PER | 1.0 | 0.9 | 0.6 | 0.3 | 0.4 | 0.4 | 0.3 | 0.2 | 0.2 | 0.1 | 0.2 |
| length (μm) | | | | | | | | | | | |
| PER | 50.0 | 30.0 | 10.0 | 3.3 | 4.0 | 4.0 | 3.0 | 1.8 | 1.7 | 0.9 | 1.4 |
| length/PER | | | | | | | | | | | |
| content | | | | | | | | | | | |
| ratio × 100 | | | | | | | | | | | |
| (μm/%) | | | | | | | | | | | |
| Electrolyte | 1460 | 1320 | 1130 | 1010 | 1080 | 1020 | 1010 | 820 | 680 | 580 | 660 |
| peel | | | | | | | | | | | |
| strength | | | | | | | | | | | |
| (gf/15 mm) | | | | | | | | | | | |

In Table 1, it can be seen that when the PER content ratio is 10% or less, the PER length is 0.3 μm or more, or the PER length/PER content ratio is 3.0 (μm/%) or more, the electrolyte peeling strength is 1,000 (gf/15 mm) or more.

In conclusion, it can be seen that Cases 1 to 7 satisfy the above conditions and are superior to Comparative Examples 1 to 4 in terms of electrolyte peeling strength.

### 4) A Method of Manufacturing a Cell Pouch (100) for a Secondary Battery

The method of manufacturing the cell pouch 100 for secondary batteries is carried out by sequentially laminating the inner resin layer 10, the barrier layer 20, and the outer resin layer 30. At this time, the outer resin layer 30 may be formed by sequentially laminating a first outer resin layer 31 and a second outer resin layer 32.

Here, when the content ratio of PER (Propylene Ethylene Rubber) of the internal resin layer 10 is 10% or less, the length of PER is 0.3 μm or more, or the length of PER compared to the content ratio of PER is 3.0 (μm/%) or more, the electrolyte peeling strength is excellent (see Table 1).

Additionally, a surface treatment layer 40 may be formed on the upper and lower surfaces of the barrier layer 20.

In addition, a first adhesive layer 51 may be formed between the second surface treatment layer 42 and the first outer resin layer 31, and a second adhesive layer 52 may be formed between the first outer resin layer 31 and the second outer resin layer 32.

In addition, a first surface treatment layer 41 may be formed between the inner resin layer 10 and the barrier layer 20, and a second surface treatment layer may be formed between the barrier layer 20 and the first outer resin layer 31.

For a more detailed explanation, the above description can be referenced with FIGS. 1 to 5.

The embodiments of the present invention described above have been described with reference to the embodiments shown in the drawings to aid understanding, but these are merely illustrative, and those skilled in the art will understand that that various modifications and equivalents are possible. Therefore, the technical protection scope of the present invention should be determined by the appended claims.

### REFERENCE NUMERAL

10: Internal resin layer 20: barrier layer
30: outer resin layer 31: first outer resin layer
32: second outer resin layer 40: surface treatment layer
41: first surface treatment layer 42: second surface treatment layer
50: adhesive layer 51: first adhesive layer
52: second adhesive layer 100: cell pouch

1. A cell pouch for a secondary battery comprising:
an inner resin layer;
a barrier layer; and
an outer resin layer,
wherein the inner resin layer, the barrier layer, and the outer resin layer are sequentially laminated,
wherein a content ratio of Propylene Ethylene Rubber (PER) in the inner resin layer is 10% or less.

2. The cell pouch of claim 1, wherein a length of the PER of the inner resin layer is 0.3 μm or more, or the length of the PER compared to the content ratio of the PER is 3.0 (μm/%) or more.

3. The cell pouch of claim 1, wherein an electrolyte peeling strength of the inner resin layer is 1,000 (gf/15 mm) or more.

4. The cell pouch of claim 1, wherein the outer resin layer includes a first outer resin layer and a second outer resin layer sequentially laminated in the outer resin layer.

5. The cell pouch of claim 4 further comprises,
a first surface treatment layer formed between the inner resin layer and the barrier layer; and
a second surface treatment layer formed between the barrier layer and the first outer resin layer.

6. The cell pouch of claim 5 further comprises,
a first adhesive layer formed between the second surface treatment layer and the first outer resin layer; and
a second adhesive layer formed between the first outer resin layer and the second outer resin layer.

7. A method for manufacturing a cell pouch for a secondary battery comprising:
placing an inner resin layer;
placing a barrier layer above the inner resin layer; and
placing the outer resin layer above the barrier layer,
wherein a content ratio of Propylene Ethylene Rubber (PER) of the inner resin layer is 10% or less.

8. The method of claim 7, wherein a length of PER of the inner resin layer is 0.3 μm or more, or a length of the PER compared to a content ratio of the PER is 3.0 (μm/%) or more.

9. The method of claim 7, wherein the outer resin layer includes a first outer resin layer and a second outer resin layer sequentially laminated in the outer resin layer.

10. The method of claim 9, wherein a first surface treatment layer is formed between the inner resin layer and the barrier layer, and a second surface treatment layer is formed between the barrier layer and the first outer resin layer.

11. The method of claim 10, wherein a first adhesive layer is formed between the second surface treatment layer and the first outer resin layer, and a second adhesive layer is formed between the first outer resin layer and the second outer resin layer.
